(19) United States
(12) Patent Application Publication
(10) Pub. No.: US 2025/0159344 A1
(43) Pub. Date: May 15, 2025

(54) IMAGE PICKUP APPARATUS AND LENS APPARATUS

(71) Applicant: CANON KABUSHIKI KAISHA, Tokyo (JP)

(72) Inventor: KAZUYA HIGUMA, Saitama (JP)

(21) Appl. No.: 18/937,537

(22) Filed: Nov. 5, 2024

(30) Foreign Application Priority Data
Nov. 13, 2023 (JP) 2023-192849

(51) Int. Cl. H04N 23/667; H04N 23/55; H04N 23/63

(52) U.S. Cl. CPC H04N 23/667; H04N 23/55; H04N 23/633

(57) ABSTRACT

An image pickup apparatus is attachable to an optical apparatus, and includes an image pickup apparatus and a processor. The optical apparatus includes a first optical system, a second optical system, and a switching unit. The optical axes of the first and second optical systems do not coincide with each other. The switching unit is capable of switching between a first mode in which the first and second optical systems can be simultaneously driven and a second mode in which one of the first and second optical systems can be driven. The processor is configured to cause a display unit to display a first display indicating a state in which the second mode is set in a case where the state of the switching unit is the second mode.

### BACKGROUND

### Technical Field

The present disclosure relates to an image pickup apparatus and a lens apparatus.

### Description of Related Art

In a conventionally known image capturing method for a stereo three-dimensional video, a compound eye lens unit with which a plurality of images from different viewpoints are obtained is connected to a typical single-lens camera body to perform image capturing. Captured images are recorded as one image in the camera body. A viewer can view a three-dimensional video when images are displayed on a device such as a head-mounted display so that an image formed in an area on the left-eye side can be viewed only by the left eye of the viewer and an image formed on the right-eye side can be viewed only by the right eye of the viewer.

Japanese Patent Laid-open No. 2023-037539 discloses a lens apparatus including a first focus adjustment unit and a second focus adjustment unit, the first focus adjustment unit being coupled to both a right-eye optical system and a left-eye optical system, the second focus adjustment unit being coupled to either of the right-eye and left-eye optical systems.

### SUMMARY

An image pickup apparatus according to one aspect of the present disclosure is attachable to an optical apparatus. The image pickup apparatus includes an image pickup apparatus and a processor. The optical apparatus includes a first optical system, a second optical system, and a switching unit. The optical axes of the first and second optical systems do not coincide with each other. The switching unit is capable of switching between a first mode in which the first and second optical systems can be simultaneously driven and a second mode in which one of the first and second optical systems can be driven. The processor is configured to cause a display unit to display a first display indicating a state in which the second mode is set in a case where the state of the switching unit is the second mode.

Further features of the disclosure will become apparent from the following description of embodiments with reference to the attached drawings.

### BRIEF DESCRIPTION OF THE DRAWINGS

FIG. 1 is a configuration diagram of a camera system according to an embodiment of the present disclosure.

FIG. 2 is a configuration diagram of a camera control unit and a lens control unit.

FIGS. 3A and 3B are schematic diagrams of focus misalignment adjustment between a right-eye optical system and a left-eye optical system.

FIGS. 4A and 4B are flowcharts for description of operation of an interchangeable lens in Example 1.

FIGS. 5A and 5B are diagrams illustrating an example of display in Example 1.

FIG. 6 is a flowchart for description of an example of operation of an interchangeable lens in Example 2.

FIGS. 7A and 7B are diagrams illustrating an example of display in Example 2.

FIG. 8 is a flowchart for description of another example of operation of the interchangeable lens in Example 2.

FIGS. 9A and 9B are diagrams illustrating another example of display in Example 2.

### DETAILED DESCRIPTION

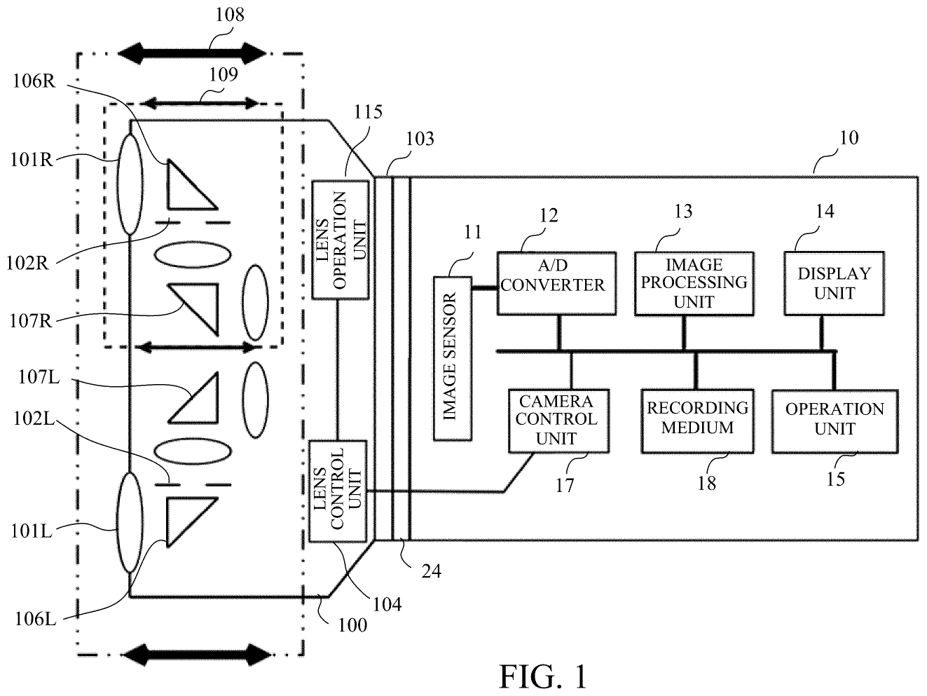

FIG. 1 is a configuration diagram of a camera system according to an embodiment of the present disclosure. The camera system includes an interchangeable lens (lens apparatus) 100 and a camera (image pickup apparatus) 10 to which the interchangeable lens 100 is detachably attached. The interchangeable lens 100 is mechanically and electrically connected to the camera 10 through a lens mount 103 and a camera mount 24. The interchangeable lens 100 receives electric power supply from the camera 10 through non-illustrated electric terminals provided at the above-described mounts. The camera 10 performs communication with the interchangeable lens 100 through non-illustrated communication terminals provided at the above-described mounts.

The camera 10 includes an image sensor 11 configured to photoelectrically convert an object image formed through a right-eye lens unit 101R and a left-eye lens unit 101L in the interchangeable lens 100 and output an electric signal. The camera 10 also includes an A/D converter 12 configured to convert the analog electric signal output from the image sensor 11 into a digital signal, and an image processing unit 13 configured to generate an image by performing various kinds of image processing on the digital signal. The image generated by the image processing unit 13 is displayed on a display unit 14 and recorded in a recording medium 18.

In addition, the camera 10 includes an operation unit 15 including a power switch for powering on and off, an image capturing switch for starting recording of an image or a motion image, and a selection/setting switch for performing setting of the camera 10 and the interchangeable lens 100. A camera control unit 17 includes a microcomputer and performs control of the image processing unit 13 and control of communication with the interchangeable lens 100 in accordance with signals from the operation unit 15.

The interchangeable lens 100 includes prisms 106R, 107R, 106L, and 107L that each change the direction of an optical axis by 90° through reflection. The interchangeable lens 100 also includes a lens control unit 104 including a microcomputer configured to control aperture and focus in accordance with a control signal received from the camera control unit 17 through communication or an operation of a lens operation unit 115. The lens operation unit 115 is an operation member including setting switches for changing lens operation and a ring operation unit for performing focus and aperture operation. The lens control unit 104 performs control in accordance with an operation on the lens operation unit 115.

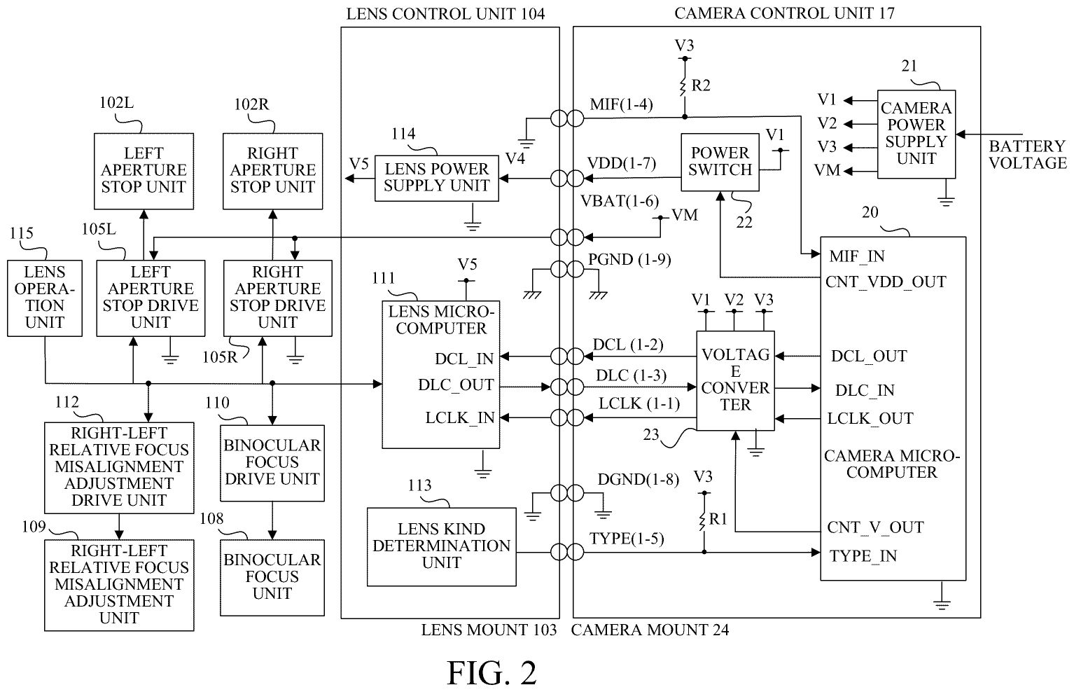

FIG. 2 is a configuration diagram of the camera control unit 17 and the lens control unit 104. An LCLK terminal (1-1) is a terminal for a communication control signal output from the camera 10 to the interchangeable lens 100. A DCL terminal (1-2) is a terminal for communication data output from the camera 10 to the interchangeable lens 100. A DLC terminal (1-3) is a terminal for communication data output from the interchangeable lens 100 to the camera 10. An MIF terminal (1-4) is a terminal for detecting mounting of the interchangeable lens 100 on the camera 10. The microcomputer (hereinafter referred to as camera microcomputer) 20 in the camera control unit 17 detects mounting of the interchangeable lens 100 on the camera 10 based on voltage at the MIF terminal (1-4). A TYPE terminal (1-5) is a terminal for detecting the kind of the interchangeable lens 100 mounted on the camera 10. The camera microcomputer 20 detects the kind of the interchangeable lens 100 mounted on the camera 10 based on voltage at the TYPE terminal (1-5). A VBAT terminal (1-6) is a terminal for supplying, from the camera 10 to the interchangeable lens 100, drive power (VM) to be used for various kinds of operation except for communication control. A VDD terminal (1-7) is a terminal supplying, from the camera 10 to the interchangeable lens 100, communication control power (VDD) to be used for communication control. A DGND terminal (1-8) is a terminal for grounding a communication control system of the camera 10 and the interchangeable lens 100. A PGND terminal (1-9) is a terminal for grounding a mechanical drive system including motors and the like provided in the camera 10 and the interchangeable lens 100.

A plurality of kinds of interchangeable lenses 100 having different voltages for communication with the camera 10 are selectively mounted on the camera 10. The following description will be made on a case where the kinds of interchangeable lenses 100 that the camera 10 identifies based on voltage at the TYPE terminal (1-5) include a first interchangeable lens and a second interchangeable lens having a communication voltage different from that of the first interchangeable lens.

A camera power supply unit 21 provided in the camera control unit 17 converts battery voltage supplied from a non-illustrated battery mounted on the camera 10 into voltage necessary for operation of each circuit. In this case, the camera power supply unit 21 generates a first voltage V1, a second voltage V2, a third voltage V3, and a voltage VM. The first voltage V1 is power voltage as the communication control power (VDD) for the first and second interchangeable lenses and is the communication voltage of the first interchangeable lens. The second voltage V2 is the communication voltage of the second interchangeable lens. The third voltage V3 is power voltage as operation power for the camera microcomputer 20. The voltage VM is power voltage as drive power for the first and second interchangeable lenses.

When a power switch 22 is turned on, the camera microcomputer 20 starts supply of the communication control power (VDD) and the voltage VM from the camera 10 to the interchangeable lens 100. When the power switch 22 is turned off, the camera microcomputer 20 stops supply of the communication control power (VDD) and the voltage VM from the camera 10 to the interchangeable lens 100.

The camera microcomputer 20 performs communication with the interchangeable lens 100 through a voltage converter 23. The camera microcomputer 20 includes an LCLK_OUT terminal that outputs a communication control signal, a DCL_OUT terminal that outputs communication data to the interchangeable lens 100, and a DLC_IN terminal that receives inputting of communication data from the interchangeable lens 100. The communication control signal and the communication data correspond to signals for communication. The camera microcomputer 20 includes an MIF_IN terminal for detecting mounting of the interchangeable lens 100, a TYPE_IN terminal for identifying the kind of the interchangeable lens 100, and a CNT_V_OUT terminal that outputs a communication voltage switching signal to the voltage converter 23. The camera microcomputer 20 further includes a CNT_VDD_OUT terminal that outputs an energization signal for the power switch 22, a terminal for connection with the image processing unit 13, and a terminal for connection with the operation unit 15.

The microcomputer (hereinafter referred to as lens microcomputer) 111 in the lens control unit 104 performs communication with the camera microcomputer 20 through the voltage converter 23. The lens microcomputer 111 includes a LCLK IN terminal that receives inputting of a communication control signal, a DLC_OUT terminal that outputs communication data to the camera 10, and a DCL IN terminal that receives inputting of communication data from the camera 10. The lens microcomputer 111 also includes terminals for connection with a right aperture stop drive unit 105R, a left aperture stop drive unit 105L, a binocular focus drive unit 110, and a right-left relative focus misalignment adjustment drive unit 112. The lens control unit 104 includes a lens power supply unit 114.

The MIF_IN terminal of the camera microcomputer 20 is pulled up to a power source by a resistor R2 (100 KΩ) and thus has a voltage value H (High) when no lens is mounted. However, the MIF_IN terminal is connected to GND in the interchangeable lens 100 (first and second interchangeable lenses) when the interchangeable lens 100 is mounted, and thus has a voltage value L (Low) irrespective of the kind of the interchangeable lens 100 at the timing at which the interchangeable lens 100 is mounted.

The interchangeable lens 100 includes the right aperture stop drive unit 105R and the left aperture stop drive unit 105L configured to drive actuators that operate a right aperture stop unit 102R and a left aperture stop unit 102L. The interchangeable lens 100 also includes the binocular focus drive unit 110 configured to operate a binocular focus unit 108. The interchangeable lens 100 further includes the right-left relative focus misalignment adjustment drive unit 112 that operate a right-left relative focus misalignment adjustment unit 109.

The right-left relative focus misalignment adjustment unit 109, which is disposed on the right-eye side in FIG. 1, may be disposed on the left-eye side. Although the two aperture stop drive units are provided in the present example, the two aperture stop units may be simultaneously driven by one aperture stop drive unit. Moreover, the binocular focus drive unit 110 may be a right-left integrated drive mechanism or may be right and left separate drive mechanisms that are simultaneously operated by separate motors.

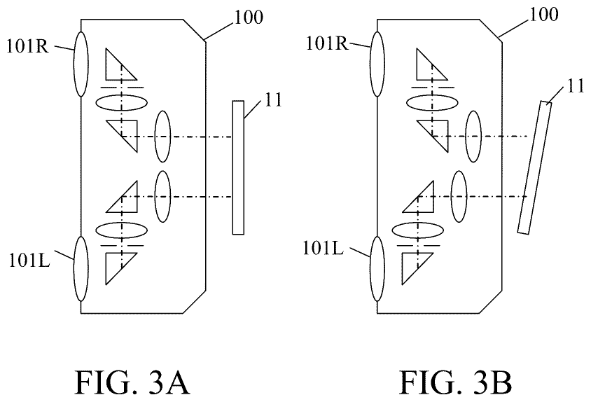

FIGS. 3A and 3B are schematic diagrams of focus misalignment adjustment of a right-eye optical system and a left-eye optical system. The right-eye and left-eye optical systems are disposed in parallel, with one functioning as a first optical system and the other as a second optical system. In a compound eye lens unit, focus misalignment of the right-eye and left-eye optical systems occurs in some cases because of variation in imaging plane inclination due to individual differences in the camera and reliability change (such as temperature, humidity, and impact). FIG. 3A illustrates a state in which the imaging plane of the image sensor 11 is not inclined. An ideal state is such that the imaging plane is not inclined as illustrated in FIG. 3A, but the imaging plane is inclined as illustrated in FIG. 3B due to individual differences in the camera in some cases. With the configuration in FIGS. 1 and 2, the focus positions of right and left eyes can be changed by using the right-left relative focus misalignment adjustment unit 109, respectively. As illustrated in FIG. 3B, the right and left optical systems are moved in synchronization by using the binocular focus unit 108 after the focus positions of right and left eyes are adjusted, which makes it possible to perform image capturing in a state in accordance with inclination of the imaging plane.

In the present embodiment, the interchangeable lens 100 operates the binocular focus drive unit 110 when its focus drive mode is a first drive mode (first mode), and operates the right-left relative focus misalignment adjustment drive unit 112 when the focus drive mode is a second drive mode (second mode). In other words, the right and left optical systems can be simultaneously driven in the first drive mode, and one of the right and left optical systems can be driven in the second drive mode.

### Example 1

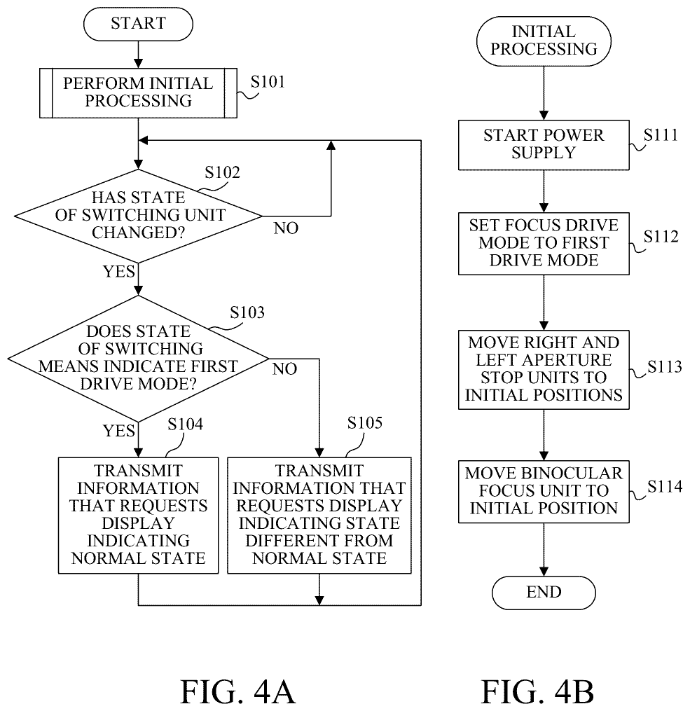

The present example describes a process that the interchangeable lens 100 operates in accordance with operation of the lens operation unit 115. FIGS. 4A and 4B are flowcharts for description of operation of the interchangeable lens 100 in the present example. Upon an operation on the operation unit 15 or mounting of the interchangeable lens 100 on the camera 10, power is supplied from the camera 10 to the interchangeable lens 100 and the process starts.

At step S101, the lens control unit 104 performs initial processing following the power supply. FIG. 4B is a flowchart illustrating the initial processing. At step S111, upon reception of the power supply from the camera 10, the lens power supply unit 114 starts power supply to each component in the interchangeable lens 100. At step S112, the lens control unit 104 sets the focus drive mode to the first drive mode. At step S113, the lens control unit 104 moves the right aperture stop unit 102R and the left aperture stop unit 102L to respective initial positions through the right aperture stop drive unit 105R and the left aperture stop drive unit 105L. The initial positions are typically positions (open positions) where the aperture is fully opened, but may be not the open positions, depending on settings of the camera 10 and the like. At step S114, the lens control unit 104 moves the binocular focus unit 108 to an initial position through the binocular focus drive unit 110. The initial position is typically a position for optically focusing at infinity but may be a position at previous power off, depending on settings of the camera 10 and the like.

At step S102, the lens control unit 104 determines whether the state of a focus drive mode switching unit included in the lens operation unit 115 has changed. The lens control unit 104 executes processing at step S103 in a case of having determined that the state of the switching unit has changed, or repeats the processing at the present step in a case of having determined that the state of the switching unit has not changed.

At step S103, the lens control unit 104 determines whether the state of the switching means indicates the first drive mode. The lens control unit 104 executes processing at step S104 in a case of having determined that the state of the switching means indicates the first drive mode. Alternatively, the lens control unit 104 executes processing at step S105 in a case of having determined that the state of the switching unit does not indicate the first drive mode, in other words, indicates the second drive mode.

At step S104, the lens control unit 104 transmits, to the camera 10, information that requests a display indicating the normal state. Accordingly, the lens control unit 104 functions as a transmission unit.

At step S105, the lens control unit 104 transmits, to the camera 10, information that requests a display indicating a state different from the normal state.

After execution of the processing at step S104 or S105, the lens control unit 104 executes processing at step S102.

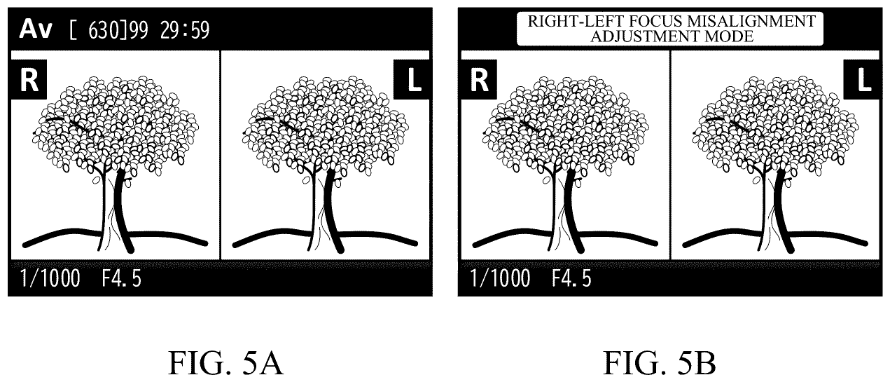

The camera microcomputer 20 receives information transmitted from the interchangeable lens 100 (information transmitted at step S104 or S105). The information transmitted at step S104 or S105 corresponds to the state of the switching unit. Accordingly, the camera microcomputer 20 functions as an acquisition unit capable of acquiring the state of the switching unit. The camera microcomputer 20 causes the display unit 14 to display a display in accordance with the received information. Accordingly, the camera microcomputer 20 functions as a display control unit that controls a display (content) displayed on the display unit 14 in accordance with the state of the switching unit. For example, the camera microcomputer 20 causes the display unit 14 to display a display (second display) illustrated in FIG. 5A in a case of having received information that requests a display indicating the normal state from the interchangeable lens 100. The display illustrated in FIG. 5A is a normal display (display indicating a state in which the first mode is set). The camera microcomputer 20 also causes the display unit 14 to display a display (first display) illustrated in FIG. 5B in a case of having received information that requests a display indicating a state different from the normal state from the interchangeable lens 100. The display illustrated in FIG. 5B is a display (display capable of notifying a user of a state in which the second mode is set) different from the normal display in FIG. 5A.

As described above, according to the configuration of the present example, a display different from the normal display is performed in a case where focus misalignment of the right and left optical systems is adjusted (the focus drive mode is the second drive mode), which makes it possible to prevent the user from accidentally performing image capturing operation.

### Example 2

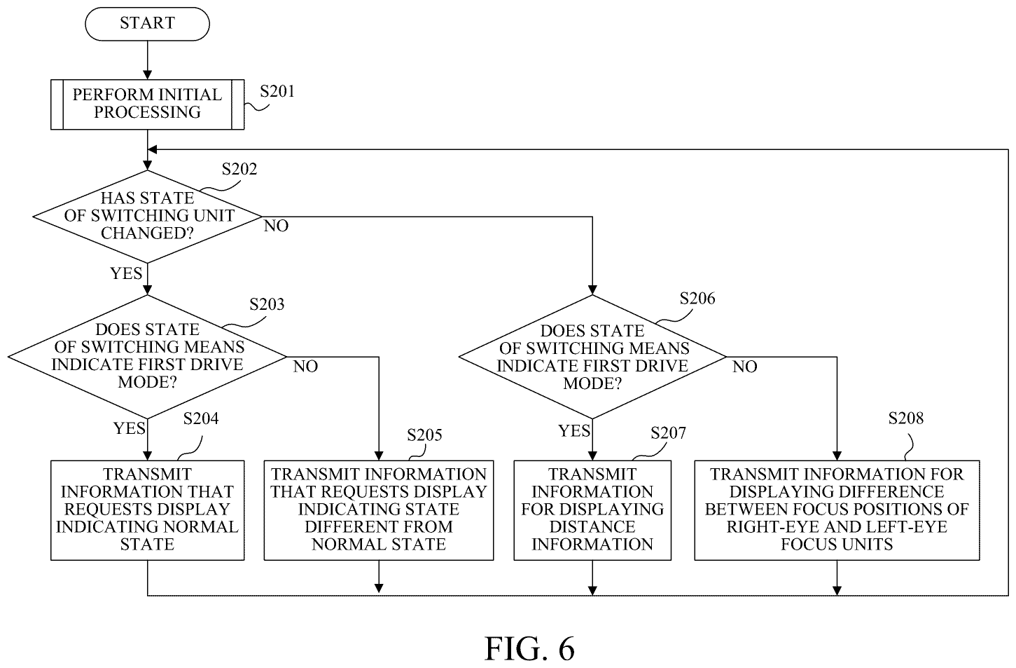

The present example describes a case where additional information is displayed in a display described in Example 1. FIG. 6 is a flowchart for description of an example of operation of the interchangeable lens 100 in the present example. Upon an operation on the operation unit 15 or mounting of the interchangeable lens 100 on the camera 10, power is supplied from the camera 10 to the interchangeable lens 100 and the process starts.

Step S201 is the same as the processing at step S101 in FIGS. 4A and 4B, and thus description thereof is omitted.

At step S202, the lens control unit 104 determines whether the state of the focus drive mode switching unit included in the lens operation unit 115 has changed. The lens control unit 104 executes processing at step S203 in a case of having determined that the state of the switching unit has changed, or executes processing at step S206 in a case of having determined that the state of the switching unit has not changed.

Processing at steps S203 to S205 is the same as the processing at steps S103 to S105, respectively, in FIGS. 4A and 4B, and thus description thereof is omitted.

At step S206, the lens control unit 104 determines whether the state of the switching means indicates the first drive mode. The lens control unit 104 executes processing at step S207 in a case of having determined that the state of the switching means indicates the first drive mode. Alternatively, the lens control unit 104 executes processing at step S208 in a case of having determined that the state of the switching unit does not indicate the first drive mode, in other words, indicates the second drive mode.

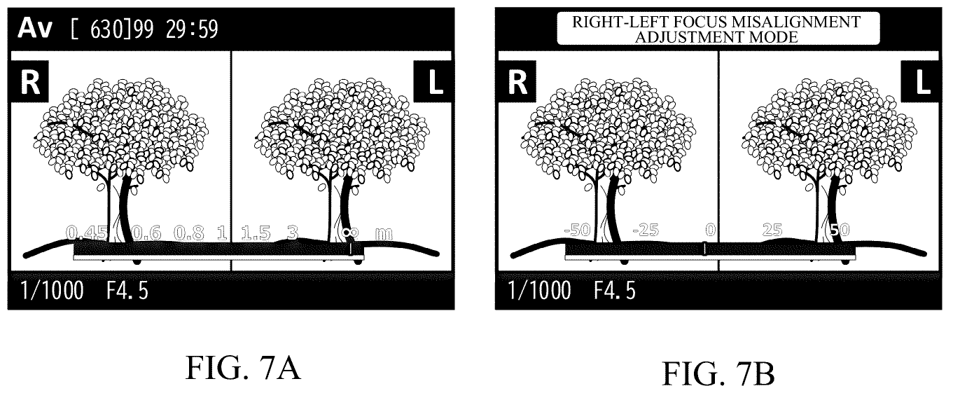

At step S207, the lens control unit 104 transmits information for displaying distance information (information related to image capturing distance) to the camera 10. The camera 10 performs a display in accordance with the information for displaying distance information. In the present embodiment, the camera 10 performs a display illustrated in FIG. 7A. Specifically, the display corresponds to the display in FIG. 5A to which a display of a bar at a lower part, a distance number above the bar, and a mark indicating the current focus position on the bar are added. With combination of these displays, the distance of the current focus position is indicated, which facilitates intuitive understanding of the current focus position within a range in which focusing is possible.

The information transmitted at step S207 includes information related to the position of the bar that displays the distance number, information related to the number that displays distance, and information related to the position of the bar that indicates the current focus position. By performing a display based on these pieces of information, the camera 10 can display information of the focus position in a manner easily understandable by the user.

At step S208, the lens control unit 104 transmits, to the camera microcomputer 20, information for displaying the difference between the focus positions of a right-eye focus unit and a left-eye focus unit. The camera microcomputer 20 performs a display in accordance with the information for displaying the difference between the focus positions of the right-eye and left-eye focus units. In the present embodiment, a display illustrated in FIG. 7B is performed. Specifically, the display corresponds to the display in FIG. 5B to which a display indicating the difference between the right-eye and left-eye focus positions is added at a place where the distance information is displayed in the display in FIG. 7A. In the display in FIG. 7B, the center of the bar is “0”, and a state in which the mark is at the position of “0” means a state in which there is no difference between the right-eye and left-eye focus positions. The positive side on the right side of “0” represents the amount of adjustment in the infinite direction, and the negative side on the left side of “0” represents the amount of adjustment in the close direction. A number on a scale indicates a range in which adjustment is possible, and indicates the number of drive pulses that can be used in adjustment because a stepping motor is assumed for focus drive in the present example. The number may be a moving amount converted for focusing or the distance of a focus lens difference. The user can understand the adjustment amounts of the right-eye and left-eye focus positions by checking the display in FIG. 7B.

The information transmitted at step S208 includes information related to positions on the bar at which numbers used on the scale for indicating the difference between the right-eye and left-eye focus positions are displayed, information related to the numbers used on the scale, and information related to the position of the bar indicating the difference between the right-eye and left-eye focus positions. By performing a display based on these pieces of information, the camera 10 can display the difference between the focus positions of the right-eye and left-eye focus units. Thus, the distance display and the focus difference display can be displayed on the camera 10 side without distinction, and which display is to be performed can be controlled based on information from the interchangeable lens 100.

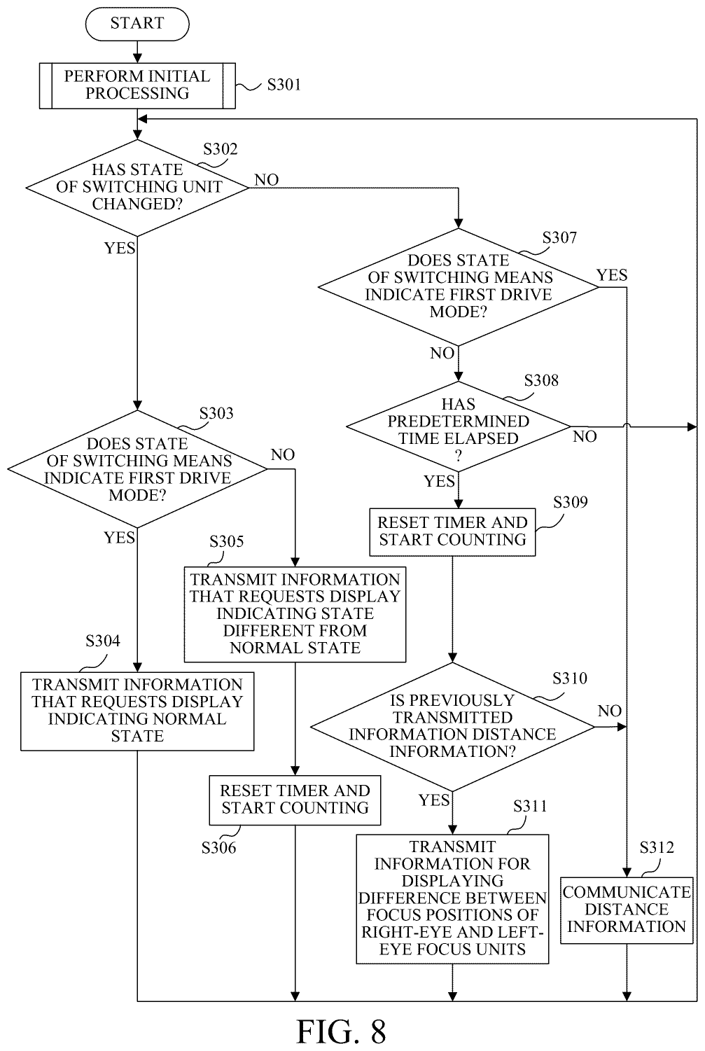

FIG. 8 is a flowchart for description of another example of operation of the interchangeable lens 100 in the present example.

Processing at steps S301 to S305 is the same as the processing at steps S201 to S205, respectively, in FIG. 6, and thus description thereof is omitted.

At step S306, the lens control unit 104 resets a timer for measuring time and then starts counting.

At step S307, the lens control unit 104 determines whether the state of the switching means indicates the first drive mode. The lens control unit 104 executes processing at step S312 in a case of having determined that the state of the switching means indicates the first drive mode. Alternatively, the lens control unit 104 executes processing at step S308 in a case of having determined that the state of the switching unit does not indicate the first drive mode, in other words, indicates the second drive mode.

At step S308, the lens control unit 104 determines whether a predetermined time has elapsed. The lens control unit 104 executes processing at step S309 in a case of having determined that the predetermined time has elapsed, or executes processing at step S302 in a case of having determined that the predetermined time has not elapsed.

At step S309, the lens control unit 104 resets the timer for measuring time and then starts counting.

At step S310, the lens control unit 104 determines whether information previously transmitted to the camera 10 is distance information. The lens control unit 104 executes processing at step S311 in a case of having determined that the information previously transmitted to the camera 10 is distance information, or executes processing at step S312 in a case of having determined otherwise, in other words, in a case of having determined that the information previously transmitted to the camera 10 is focus misalignment information.

Processing at steps S311 to S312 is the same as the processing at steps S208 to S207, respectively, in FIG. 6, and thus description thereof is omitted.

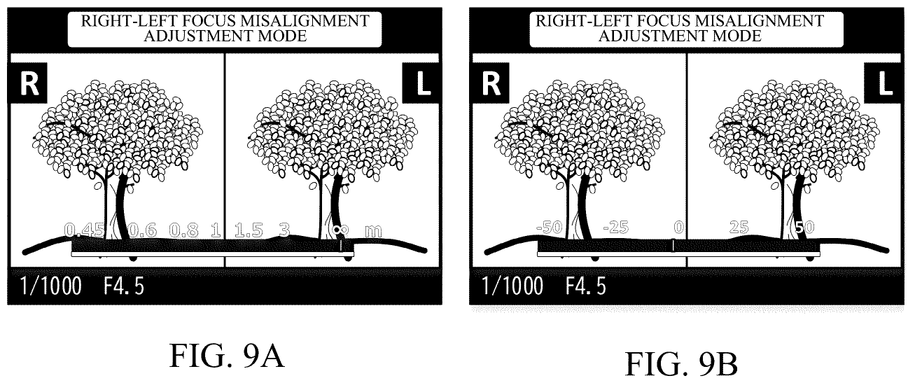

By performing the above-described processing, the camera 10 alternately displays FIGS. 9A and 9B in each cycle of the predetermined time. The camera 10 may alternately display distance information of the right-eye optical system and distance information of the left-eye optical system in each cycle of the predetermined time.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

According to the present disclosure, it is possible to provide an image pickup apparatus capable of preventing motion image capturing from accidentally starting while focus misalignment between right and left optical systems is adjusted.

This application claims priority to Japanese Patent Application No. 2023-192849, which was filed on Nov. 13, 2023, and which is hereby incorporated by reference herein in its entirety.

What is claimed is:

1. An image pickup apparatus to which an optical apparatus is attachable, the image pickup apparatus comprising:
an image pickup element; and
a processor,
wherein the optical apparatus including a first optical system, a second optical system, and a switching unit, optical axes of the first and second optical systems not being coinciding with each other, the switching unit being capable of switching between a first mode in which the first and second optical systems can be simultaneously driven and a second mode in which one of the first and second optical systems can be driven,
wherein the processor is configured to cause a display unit to display a first display indicating a state in which the second mode is set in a case where the state of the switching unit is the second mode.

2. The image pickup apparatus according to claim 1, wherein the processor is configured to cause the display unit to display a second display indicating a state in which the first mode is set in a case where the state of the switching unit is the first mode.

3. The image pickup apparatus according to claim 1, wherein the first display includes information related to a difference between focus positions of the first and second optical systems.

4. The image pickup apparatus according to claim 1, wherein the display unit alternately displays, as the first display, a display including information related to an image pickup distance of one of the first and second optical systems and a display including information related to a difference between focus positions of the first and second optical systems.

5. The image pickup apparatus according to claim 1, wherein the display unit alternately displays, as the first display, a display including information related to an image pickup distance of one of the first and second optical systems and a display including information related to an image pickup distance of the other of the first and second optical systems.

6. An optical apparatus that is attachable to an image pickup apparatus, the optical apparatus comprising:
a first optical system;
a second optical system having an optical axis which does not coincide with an optical axis of the first optical system;
a switching unit capable of switching between a first mode in which the first and second optical systems can be simultaneously driven and a second mode in which one of the first and second optical systems can be driven; and
a processor configured to transmit information that requests display of a first display indicating a state in which the second mode is set to the image pickup apparatus in a case where a state of the switching unit indicates the second mode.

7. The optical apparatus according to claim 6, wherein the processor configured to transmit information that requests display of a second display indicating a state in which the first mode is set to the image pickup apparatus in a case where the state of the switching unit is the first mode.

8. The optical apparatus according to claim 6, wherein the processor transmits information related to a difference between focus positions of the first and second optical systems in a case where the state of the switching unit is the second mode.

9. The optical apparatus according to claim 6, wherein in a case where the state of the switching unit is the second mode, the processor alternately transmits information related to an image pickup distance of one of the first and second optical systems and information related to a difference between focus positions of the first and second optical systems.

10. The optical apparatus according to claim 6, wherein in a case where the state of the switching unit is the second mode, the processor alternately transmits information related to an image pickup distance of one of the first and second optical systems and information related to an image pickup distance of the other of the first and second optical systems.
